(19) United States
(12) Patent Application Publication
(10) Pub. No.: US 2012/0242073 A1
(43) Pub. Date: Sep. 27, 2012

(54) Method and Apparatus of Constructing Miniature Diplomas and Transcripts

(76) Inventor: Felecia Renee Mills, Frisco, TX (US)

(21) Appl. No.: 13/239,684

(22) Filed: Sep. 22, 2011

Related U.S. Application Data
(63) Continuation of application No. 29/372,836, filed on Jan. 20, 2011.

(51) Int. Cl. B42D 15/00

(52) U.S. Cl. 283/85

(57) ABSTRACT

Miniature diplomas and/or miniature transcripts may be printed on PVC plastic cards using an ID card printer. The front of a miniature diploma may display or image of a regular diploma, including scanned signatures of school officials. The front of a transcript may display dates of attendance, courses taken, grades, and scanned signature of a registrar. A plurality of information may furthermore be printed on card backs. An ID card printer with or without a lamination module may be used. Methods are furthermore disclosed for planning the tasks related to printing miniature diplomas and/or miniature transcripts onto PVC plastic cards.

### PRIORITY

The present application is a continuation of design application 29/372,836 filed on Jan. 20, 2011

### FIELD OF THE INVENTION

The present invention relates to miniature documents or certificates and methods and apparatus for producing miniature documents or certificates.

### SUMMARY

Miniature diplomas, transcripts, or other official documents and certificates may be printed on color or white PVC cards using an identification (ID) card printer. In some embodiments, an ID card printer may not comprise a lamination module. In some embodiments, an ID card printer may comprise a built-in lamination module, and may add laminate to one or both sides of the cards. Further aspects of the disclosure are described in the detail below.

### BRIEF DESCRIPTION OF THE DRAWINGS

Disclosed embodiments will be apparent when consideration is given to the following detailed description, in which:

FIG. 1 shows a side view of an example card without a laminate coating.

FIG. 2 shows a side view of an example card with a laminate coating.

FIG. 3 shows a front view of an example high school or college miniature diploma.

FIG. 4 shows a back view of an example high school or college miniature diploma.

FIG. 5 shows a front view of an example college miniature transcript.

FIG. 6 shows a back view of an example college miniature transcripts.

### DETAILED DESCRIPTION

In some embodiments, miniature diplomas and transcripts are printed on plastic cards, such as color or white graphic quality 100% Polyvinyl Chloride (PVC) plastic cards, using an ID card printer which may or may not comprise a built in lamination module.

A high school or college miniature diplomas may comprise, in one example embodiment, an exact replica of a regular 8½×11 size diploma, on a PVC card that is the side of an average credit card.

In some embodiments, a miniature wallet size diploma may provide proof of having completed high school and/or college. A miniature transcript may furthermore provide a copy of courses taken if one should transfer schools to complete their education or seek employment.

In some embodiments, a miniature diploma may serve as a legal document signed by a principal, president or other school officials. The miniature diploma may also serve as a souvenir of one's accomplishments, for example, of having graduated from high school and/or college. Similarly, a miniature transcript may serve as a legal document signed by a registrar in case a student transfers between schools to further their education. The miniature documents may therefore facilitate preservation of the integrity of school accreditation.

In some embodiments, a front of a miniature diploma may display a plurality of information, such as name of school, city & state, student's full name, type of award, dates of graduation, signatures (e.g. signatures of a principle or other school officials), school image (e.g. a sketched image of the school), and holograph (e.g. a holographic picture of a cap & gown).

In some embodiments, a back of a miniature diploma may display information such as name of school, student ID #, and reorder information (e.g. phone number & website for reordering, if lost or stolen). Miniature diplomas may generally be similar in size and shape to a regular credit card.

In some embodiments, miniature transcripts may be printed on slightly larger plastic cards, using an ID card printer. A miniature transcript may serve as proof of student transcript information, while also providing a souvenir of one's accomplishments.

In some embodiments, a front of a miniature transcript may display a plurality of information, such as name of school, city & state, field of study, student's full name, courses taken, credits awarded, Grade Point Average (GPA), and signatures (e.g. a signature of a school registrar).

In some embodiments, a back of a miniature transcript may display a name of school, student ID #, and reorder information. Miniature transcripts may be similar in size and shape to a regular credit card, or may be slightly larger to allow for increased legibility.

In some embodiments, miniature diplomas and/or miniature transcripts may be produced using an ID card printer with or without a built in lamination module.

PVC cards may be adapted to be used in an ID card printer with or without a built-in lamination module. For example, graphic quality 100% PVD plastic cards comprise a plastic exterior which meets the increasing demand for a sturdy card, and provides a reliable diploma, transcript, or other certificate. Such cards are furthermore available in the size of a regular credit card. PVC cards may be printed with more printed information, and also allow for production of miniature diplomas and/or miniature transcripts that are unique and tamper-resistant.

In some embodiments, an ID card printer may include High Definition Printing (HDP) technology that prints using dye-sublimation which prints crisp, 300 dots per inch (dpi) images on plastic cards. Dye-sublimation is a print method which card printers use to produce smooth, continuous images that look photographic. In some embodiments, a layer of resin black or color resin ink may be applied to a PVC plastic card. The ink may be permanently affixed so it cannot be removed.

In some embodiments, an ID card printer may be selected which uses HDP technology, and that also ensures uninterrupted Direct-To-Card (DTC) printing. The ID card printer may print and encode using dye-sublimation.

During the printing process the ID card printer may, for example, apply a layer of black or color resin ink to a card, and create images which are permanently affixed to the card. Cards may then be processed through one pass on a conveyor. A layer of transparent film may be applied edge-to-edge for smooth coverage. The sublimation process applies heat and a substrate transparent film material to the cards, and may trim remaining substrate transparent film for a clean, flawless finish. Once the cards are printed, they are protected from moisture by a transparent film which is tightly adhered to the cards. Resulting cards may, for example, resemble credit cards in their resilience. Advantages in using an ID card printer include the ability to add clear over-laminates to one or both sides of a card for maximum durability and security.

ID card printers with a lamination module may offer choices of laminate. For example, PolyGuard laminate and/or Thermal Transfer laminate may be sued. Thermal Transfer laminate is a relatively thin material which covers a card and provides a medium level of card durability and security. PolyGuard laminate is a thicker material which provides an extremely high level of card durability. In addition to varying card thickness, the various lamination choices require different heat settings and lamination speeds. Either lamination choice may be selected depending on the desired properties of particular embodiments.

In some embodiments, a holographic image to be inserted on a miniature diploma may be pre-approved by a principle, president, or other school official responsible for making that decision. To produce a card, information such as high school or college information, student names, date of award, and other pertinent details may be typed or otherwise entered on a computer with the required software. Scanned signatures and holographic images or sketches may also be entered and inserted on a miniature diploma. Combined card information may then be sent to a printer for production. The card may be used, for example, by a graduate entering the work force to show proof of educational accomplishments, and may also find uses in the hiring process.

The front of a mini transcript may be produced similarly as a miniature diploma, but the transcript may include information such as name of school, city & state, field of study, student's full name, courses taken, credits awarded, GPA, a signatures (e.g. authentic scanned signatures of a registrar). Schools may be advised that miniature transcripts are now available for their students.

On the back of a mini transcript, a plurality of school information may be inserted, which may include, for example, school name, student ID #, school telephone number, or reorder information. Back of card information may be typed or otherwise entered on a computer, and sent to a printer for production.

One aspect of the invention includes planning the tasks related to printing the miniature transcripts onto graphic quality cards using an ID card printer. Another aspect includes the completed card product, e.g., as a souvenir, as a document coinciding or relating to school attendance, to show proof of education accomplishments, and which may be used during the hiring process.

An advantage of laminating cards includes making the image level of the cards virtually impossible to counterfeit. The process of applying an over-laminate that bonds to the surface of a card may significantly protect data from being altered or scratched, and may produce a heavy duty construction card. Single or double sided lamination may be applied, for example, all in the same pass as cards are printing. In some embodiments, lamination layers may produce a security level of images that is sturdier than the standard overlay, while also ensuring maximum durability and protection from abrasion, color fading, dye-migration, and tampering. In some embodiments, options of whether to use an ID card printer with or without a lamination module may be considered, and plans for both options may be compared.

The addition of a lamination module may add costs to the card production process. Lamination modules may be factory installed, or can be installed at a later time using, for example, an installer Compact Disk (CD). The decision of whether to use an ID card printer with or without a lamination module may in some embodiments also be subject to individual preferences. Reliable, sturdy miniature diplomas and/or miniature transcripts may be produced with or without the lamination module.

The lamination module may add a substratum layer of transparent laminate to the front and back sides of the cards for additional durability and to extend the life of the card. Laminate may be permanently affixed to a card, allowing a miniature diploma and/or miniature transcript to withstand years of use and providing a substantially secure, permanent overlay. Laminated miniature diplomas and/or laminated transcripts may for example be similar in size and shape to a regular driver's license.

Cards may then be processed through a lamination module in one pass on a conveyor. A layer of transparent laminate may be applied edge-to-edge for smooth coverage. The lamination process applies heat and a substrate transparent laminate material to the cards, and may trim remaining laminate for a clean, flawless finish. Once the cards are laminated, they are protected from moisture by a laminate which is tightly adhered to the cards. Resulting cards may, for example, resemble credit cards in their resilience. Advantages in using a lamination module include the ability to add clear over-laminates to one or both sides of a card for maximum durability and security. (use 0075 non-laminate)

In some embodiments, cards for use with the present disclosure may for example range from 0.10-0.60 millimeters thick, although other thickness ranges are possible and embodiments need not be limited to any specific thickness. Card sizes such as CR-70 & CR-80 may be used, which are standard sizes of credit cards. Larger CR-90 & CR-100 cards may also be used in some embodiments. For the production of the miniature diplomas, the CR-80, 0.30-0.60 millimeter 100% PVC plastic cards may be used in one example embodiment. For the miniature transcripts, the CR-90 or CR-100, 0.30-0.60 millimeter 100% PVC plastic cards may be used in one example embodiment, because they are larger cards and can hold the additional printed material associated with transcripts. Example PVC card materials include 100% PVC; and 40% Polyester/60% PVC, both of which are capable of producing wallet-size sturdy cards.

In some embodiments, it may be difficult to visibly differentiate whether a card was printed using a lamination module. Only someone familiar with the equipment or closer inspection may decipher whether laminate was added. The ability to offer multiple card options simultaneously may allow for offering plans with several selectable options to be compared.

In some embodiments, ID card printer models that may be used to produce graphic quality cards may include: Fargo, Persona, UM, NISCA, Zebra, Evolis, Rainbow, Datacard, Eltron, Magicard, & DYMO models. The Fargo ID card printer comes in the following series: DTC 300, DTC 400, DTC 500, DTC 550, CardJet410, CardJet C7, DTC 710, DTC 720, and HDP 600. The Fargo Duplex ID card printers with lamination model are: DTC 500, HEW 600, & HDP 800. The DTC-LC and HDP-LC models offer a lamination module. The HDP 800 series may print using the CR90-CR100 larger PVC cards. The Persona ID card printers include: Persona C30, C7, and C25. Persona with lamination models are: Pro LX & Pro L. PVC cards are available in an array of multi colors, including a metallic gold and silver, while the standard cards are all generic colors including white, yet all cards are similar to credit or charge cards, and all cards may be used in connection with the embodiments disclosed herein.

Methods for use in connection with the present disclosure may include steps from contacting the principal or president of a particular school to getting the miniature diplomas into the student's hand, for example, as souvenir or certificate. In some embodiments, example method steps may comprise the following;

Provide instructions to school officials. In some embodiments, a CD package with all forms and instructions may be provided to school officials for the graduates. The package may, for example, include an information card for the correct spelling to a graduate's full name, school name & date of graduation. A brochure with items of other school memorabilia may be available for graduates, and all items purchased may be distributed by school officials during graduation rehearsal. If a miniature diploma is lost or stolen, additional cards can be reordered online using an approved tracking system which validates the reorder information.

Receive school data. Date may be received from school officials. Data may include, for example, a spreadsheet received via email, facsimile or mail, including the full names of graduating seniors to the high school or college, school name, city & state, date of graduation, type of award, and signatures of the officials that are to be included on the miniature diplomas. Orders may be received online or through the school, and may optionally be restricted to only current school years graduates.

Insert additional data. After a spreadsheet of graduating students is received, other information may be inserted into the miniature documents. The information may include: the full name of the graduating seniors of the high school or college, school name, city & state, date of graduation, signatures of school officials responsible at that time, and holographic image(s). This information may be inserted using a computer.

Prepare electronic card design files. Card production methods may be implemented in part by software in a computer system. For example, in one embodiment, MICROSOFT WORD® software and the Asure ID software provides a business card format which may be used to design custom miniature diplomas. In some embodiments, diploma may duplicate an 8½×11 original diploma and may comprise a same aesthetic appearance as a regular size diploma, only smaller. The electronic design file(s) may be transferred software associated with an ID card printer.

Receive approvals and signatures. Approval from school officials may be accompanied by authentic signatures of those responsible at a school. In some embodiments, this information may also accompany a spreadsheet that may be faxed or sent to the spreadsheet comprising graduate information. Information may be inserted such as name of school, city & state, graduate's first, middle & last name, date of graduation, principal or president's name, and names of other officials to be inserted onto the miniature document.

Produce cards. Card information may be entered, and the cards may be printed, proofed for accuracy, and sent to school officials. In some embodiments, card production processes that comprise a watermark image, custom hologram, and/or original signatures of school officials may offer a higher level of authenticity to the exterior of the miniature diploma.

In some embodiments the following information may be added in card production; name of school, city & state, field of study, student's full name, dates of attendance, courses taken, credits awarded, GPA, and scanned signature of registrar. The signature of the registrar may be scanned onto a document, and sent to the printer.

In some embodiments, an ID card printer for production of miniature diplomas and transcripts may comprise a dual hopper which may hold up to 200 cards. An ID card printer for production of miniature diplomas and transcripts may furthermore comprise a window that permits viewing remaining card supply, while keeping blank cards dust free. Once cards are placed in a dual hopper, production information may be sent from the computer directly to the ID card printer, and the cards may be printed. After printing each card, each card may be proofread for accuracy, and the cards may be sent to school officials for distribution.

In some embodiments, an ID card printer may be equipped with an internal card “flipper” that prints the first side of a card, flips the card and prints the back side with black resin, color ink resin that is permanently affixed. In some embodiments, an ID card printer may hold two different sizes of cards with different thicknesses, may be switchable among different card sizes. In some embodiments, an ID card printer may use either or both of two different DTC printing methods: a dye-sublimation method may be used for vivid colors of accurate photographic images, and a monochrome resin and resin thermal transfer method may be used for sharp black text which can easily be read by infrared or visible light scanners. In some embodiments, an ID card printer may use an intuitive smart screen Liquid Crystal Display (LCD) control panel to display helpful messages. A card hopper lock may help prevent theft or valuable preprinted, smart or holographic cards. Print security software may add password-controlled access to an ID card printer, while providing tight control over ID card printer access and use. Print security software also can notify key personnel by text message or email whenever printing is attempted outside of authorized hours.

In some embodiments, miniature diplomas and transcripts may be personalized and/or customized to reflect achieved recognition items. School officials may be allowed to create custom holographic designs, such as a school mascot or emblem, to ensure that cards are unique. Custom holograms are extremely difficult and cost-prohibitive for counterfeiters to recreate, so it may be desirable in some embodiments to maximize the functionality.

A card's exterior structure may significantly extend the life of the card. Exteriors sealed with a “generic or stock” holographic image may protect a card, discourage card tampering or forgery, visibly make miniature diplomas unique in appearance, and secure authenticity of a card comprising original signatures.

Track card information. Signature items may be securely and chronologically kept for future ordering, and later if a miniature diploma is lost, stolen, or misplaced it can then be reordered through an on-line network site, but only if reorder information is validated through a tracking system with the original signatures of a school official. In some embodiments, only information for cards that have been produced and signed by school officials may be saved in an approved tracking system for future online reordering.

The various drawings illustrate cards and ID card printer as described herein, and furthermore illuminate card production methods as described herein.

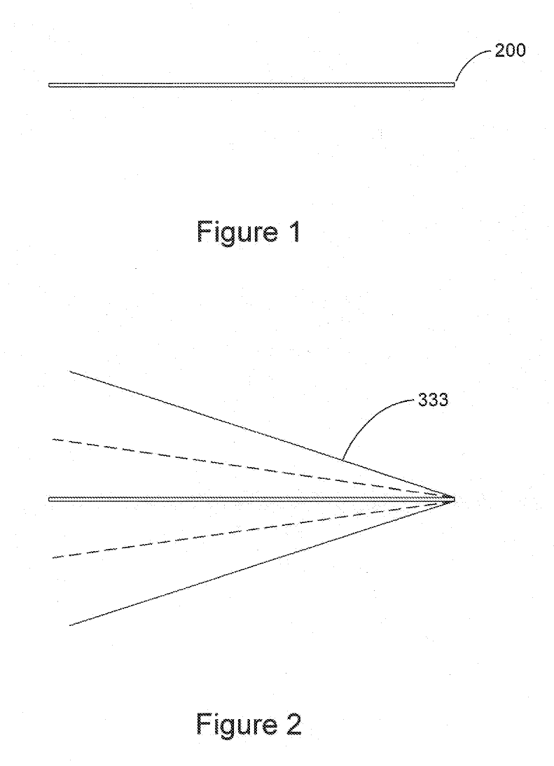

FIGS. 1 & 2 shows a side-view of a card 200 such as a graphic quality 100% PVC plastic card without laminate. The card 200 may be printed, for example, on the CR-80 through CR-100 cards, and may comprise a thickness in the range of, for example, 0.10 to 0.60 millimeters.

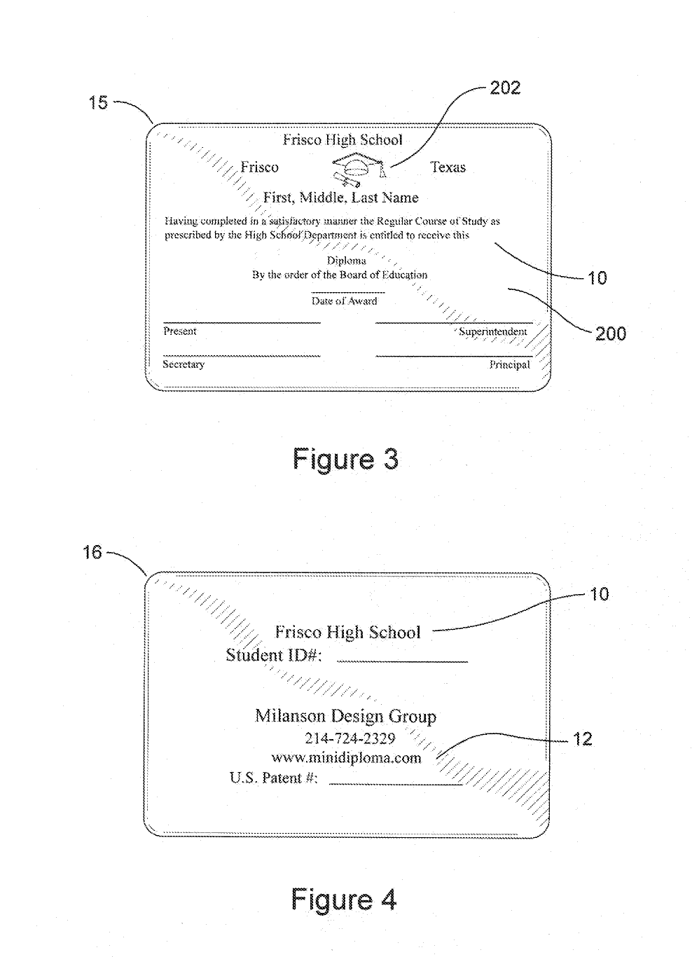

FIG. 3 shows a front half 15 for an example miniature diploma 200. The front 15 half may be fabricated with an infrared layer of black resin ink 10, custom hologram 202, or watermark image 202, which may be permanently affixed onto the miniature diplomas 200 and securely printed thereon. In some embodiments, custom hologram 202 or watermark image 202 may comprise a unique symbol to each individual card 200. A custom hologram 202 offers a higher level of security to the mini diploma 200.

FIG. 4 shows a back half 16 of an example miniature diploma 200. The back half 16 may be fabricated with an infrared layer of black resin ink 10, or color resin ink 12, which may be permanently affixed onto the miniature diplomas 200 and securely printed thereon.

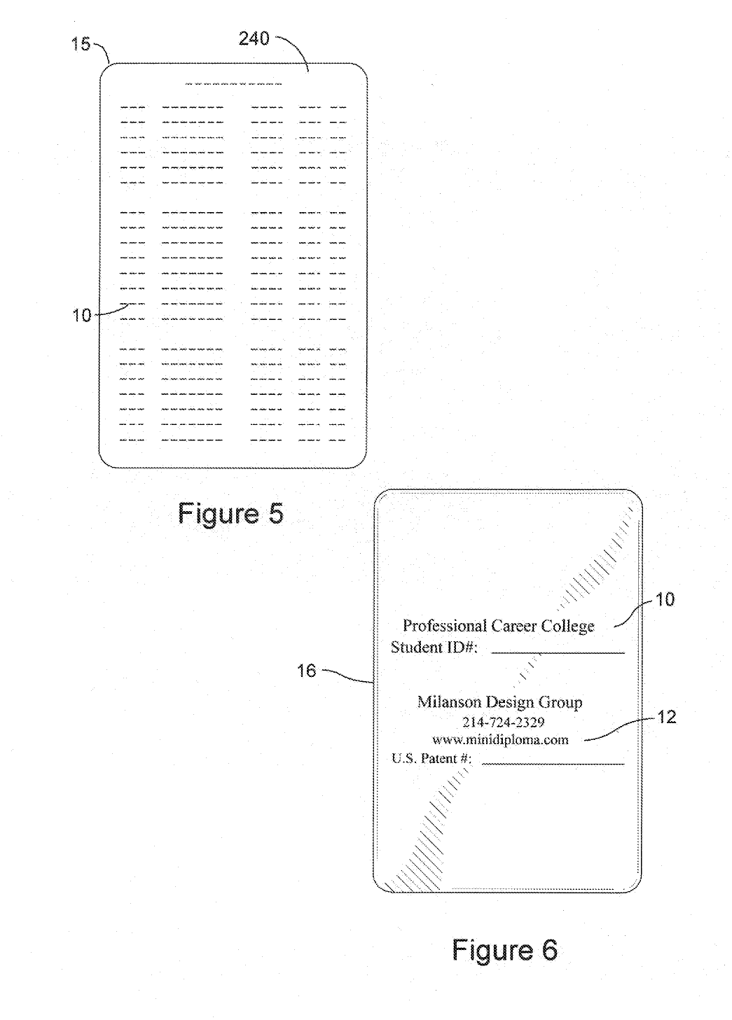

FIG. 5 shows a front view of a miniature transcript 240. The front half 15 may be fabricated with an infrared layer of black resin ink 10 which may be permanently affixed onto the miniature transcript.

FIG. 6 shows a back view of a miniature transcript 240. The back half 16 may be fabricated with an infrared layer of black resin ink 10, or color resin ink 12 which may be permanently affixed onto a miniature transcript 240 and may be securely printed thereon.

In some embodiments, a non-laminated miniature diploma or transcript product may be provided for compliance with an accreditation process, the miniature diploma or transcript comprising a single layer of resin black or color resin ink applied as a permanently affixed coating to a graphic quality 100% PVC plastic card. The layer of ink may be printed on a front side, the card may be flipped, and additional information may be printed on the back side.

in some embodiments, a method of printing or manufacturing a non-laminated product on a card may be performed using an assembly that may be substantially flat across the entire width and length of a card, wherein each card may be individually processed through an ID card printer, and each miniature diploma and/or transcript may be printed with resin black or color resin ink using the ID card printer.

In some embodiments, an assembly may be provided for creating miniature diplomas and miniature transcripts, wherein a card non-lamination or lamination member may comprise a line of symmetry printed with resin black or color resin ink that doesn't allow for smudges or smears, but consistently prints crisp concise documents.

In some embodiments, an assembly may be provided in which resin black or color resin ink is adhered entirely on one side of a card, the card is then flipped in an ID card printer, and the process in repeated on the back side of the card.

In some embodiments an assembly may be provided wherein said assembly is no greater than 0.50-0.60 millimeters thick.

In some embodiments, a laminated product may comprise a PVC card characterized by front and back halves of the card defining miniature diplomas or miniature transcripts, and with a transparent laminate coating permanently affixed to the PVC card to make it tamper resistant.

In some embodiments a method of manufacturing a card with already applied resin black or color resin ink, then affixing a thin layer of laminate to a permanent material substrate that has completely covered all edges and sides without any rough edges.

In some embodiments a single layer of PolyGuard laminate and Thermal Transfer laminate may be affixed to a front and back side of a card. The laminate may define a substrate having pressure sensitive material made of PolyGuard or Thermal Transfer laminate material affixed to the card. Once the pressure sensitive adhesive is applied, it becomes permanently adhered to the card.

In some embodiments a sheet of over-laminate film may be juxtaposed to an adhere to front and back sides of a card.

In some embodiments a transparent layer of laminate may be applied to one passing to one or both sides of a card using an ID card printer lamination module.

In some embodiments a card may have a line of symmetry completely covering and adhering to each corresponding card. A lamination may comprise a permanently affixed coating or a non-release film, which cannot be removed from the PVC card.

In some embodiments a transparent laminate may be secured to a card substrate by exposed pressure sensitive adhesive, whereby the laminate is adhered to the card.

In some embodiments a process of applying a substratum layer of Thermal Transfer or PolyGuard laminate may apply heat and pressure over a card surface, allowing the card to be tamper resistant using an ID card printer with a built in lamination module.

In some embodiments a method of manufacturing a product may be performed using an ID card printer which comprises a dual card hopper and which allows printing on two completely different card stocks that can be switched from one type card to another in one single application, and which makes the miniature diploma and/or transcript more difficult to duplicate.

In some embodiments a method of printing using an ID card printer without a built in lamination module may comprise printing a product that uses graphic quality 100% PVC plastic cards on a printer with a dual hopper that will hold up to 200 PVC cards, a window that allows viewing remaining card stock, an internal card flipper that prints one or both sides of a card, a powerful print engine that may, for example, include 4 MB RAM and can print at a speed of for example, 133 color and 500 standard cards per hour, allows for two different card sized such as CR-70 & CR-80, and/or the slightly larger CR-90 & CR-100 sizes, allows printing cards with different thicknesses ranging, for example, from 0.10 to 0.60 millimeters thick; prints with resin black or color resin ink that once printed is permanently affixed, uses dye-sublimation to produce smooth, continuous images that look photographic, uses two different direct-to-card printing methods, dye sublimation for vivid colors and the resin thermal transfer for sharp black text, displays an intuitive smart screen LCD control panel and displays helpful messages, includes print security software that adds password-controlled access to the ID card printer to support tight control over printer access and use and optionally notify key personnel by text Message or email whenever printing is attempted outside authorized hours, and prints edge-to-edge on standard graphic quality 100% PVC plastic cards.

In some embodiments a method of printing using an ID card printer with a built in lamination module may comprise printing a product on PVC plastic cards and then applying laminate to the PVC cards using an ID card printer with a built in lamination module, and manufacturing a product designed to apply laminate edge-to-edge onto the PVC cards.

In some embodiments an ID card printer with a lamination module may offer two choices of laminate, a PolyGuard laminate or a Thermal Transfer laminate. The Thermal Transfer laminate may comprise a relatively thin material which offers a medium level of protection, while the PolyGuard laminate may comprise a thicker material which provides a high level of card durability. Both can be used to produce PVC cards which may range, for example, from 0.10 to 0.60 millimeters thickness.

Although the present invention and its advantages have been described in detail, it should be understood that various changes, substitutions, and alterations can be made without departing from the spirit and scope of the invention as defined by the appended claims.

1. A miniature diploma comprising:
a wallet-size graphic quality 100% PVC miniature diploma card with a CR-70 or a CR-80 card size and a thickness from 0.50-0.60 millimeters;
a resin ink formed on the card at 300 dots per inch (dpi) resolution, wherein the resin ink is irremovably affixed to the card by High Definition Direct-to-Card Printing, such as dye-sublimation, and wherein the resin ink is formed to render diploma information printed on a front side of the card, the diploma information comprising at least a name of a school, officials signatures, and name of a graduate;
an official school image comprising a hologram formed on the front side of the card; and
a card comprises a non-laminate layer; or a layer of transparent laminate formed over the front and back sides of the card,

2. The miniature diploma of claim 1, wherein the card comprises a CR-80 type card.

3. The miniature diploma of claim 1, further comprising resin ink formed to render second diploma information printed on a back side of the card the second diploma information comprising one or more of a name of a school, a student ID number, and card reorder information.

4. A miniature transcript comprising:
a wallet-size graphic quality 100% PVC miniature transcript card with a CR-80, CR-90, or CR-100 card size and a thickness form 0.50-0.60 millimeters; and
a resin ink formed on the card at 300 dots per inch (dpi) resolution, wherein the resin ink is irremovably affixed to the card by High Definition Direct-to-Card Printing, such as dye-sublimation, and wherein the resin ink is formed to render transcript information printed on a front side of the card, the transcript information comprising at least a student name and an identification of a course completed by the named student;
an official school image comprising a watermark image formed in the card; and
a card comprises a non-laminate layer; or a layer of transparent laminate formed over the front and back sides of the card.

5. The miniature transcript of claim 4, where in the card comprises a CR-90 or CR-100 type card.

6. The miniature transcript of claim 4, further comprising resin ink formed to render back of card transcript information printed on a back of the card, the back of card transcript information comprising one or more of a name of a school, a student ID number, and card reorder information.
